(19) United States
(12) Patent Application Publication
(10) Pub. No.: US 2006/0004729 A1
(43) Pub. Date: Jan. 5, 2006

(54) Accelerated schema-based validation

(75) Inventors: Maxim Zhilyaev, Fremont, CA (US); Michael Hanson, Menlo Park, CA (US); Brian Roddy, San Francisco, CA (US)

Correspondence Address: VAN PELT, YI & JAMES LLP, 10050 N. FOOTHILL BLVD #200, CUPERTINO, CA, 95014, US

(73) Assignee: Reactivity, Inc.

(21) Appl. No.: 11/173,172

(22) Filed: Jun. 30, 2005

Related U.S. Application Data
(60) Provisional application No. 60/584,780, filed on Jun. 30, 2004.

(51) Int. Cl. G06F 17/30

(52) U.S. Cl. 707/3

(57) ABSTRACT

Performing accelerated validation of a set of data is disclosed. A structure associated with the set of data is identified. It is determined whether the structure matches a previously learned structure. If a match is found, an accelerated validation of the first set of data is performed using validation information associated with the previously learned structure.

### CROSS REFERENCE TO OTHER APPLICATIONS

This application claims priority to U.S. Provisional Patent Application No. 60/584,780 (Attorney Docket No. REACP003+) entitled ACCELERATED SCHEMA-BASED VALIDATION filed Jun. 30, 2004 which is incorporated herein by reference for all purposes.

### BACKGROUND OF THE INVENTION

Computer systems may exchange data, e.g., via a network or other connection or path, in many forms. Abstract Syntax Notation number One (“ASN.1”) and extensible markup language (“XML”) are two of many powerful tools currently used widely to represent and exchange data. For example, XML is a meta-language that allows one to define how data will be represented in a manner understandable to others across platforms, applications, and communications protocols. The current version of XML, XML 1.0 (2nd Ed.), is specified by the World Wide Web Consortium (W3C) in the W3C Recommendation entitled “Extensible Markup Language (XML) 1.0, Second Ed.”, dated Aug. 14, 2000, available at http://www.w3.org/TR/REC-xml, which specification is incorporated herein by reference for all purposes.

XML may be used to exchange data for many useful purposes. One growing area of use is the web services sector. The term “web services” refers generally to the idea of using a first computer, e.g., an application server, to perform computations or other processing tasks for one or more other computers that have access to the first computer via a network, such as the World Wide Web. For example, a client computer may be configured to invoke an application or other process running on a server computer with which the client is configured to communicate via a network by sending to the server a “remote procedure call” identifying, e.g., the processing to be performed and providing the input data, if any, required to perform the operation. Depending on the nature of the application or process running on the server and/or the remote procedure call (RPC), the server may be configured to return to the client (or some other destination) some result of the processing or computation performed by the server. For example, a web-based airline reservation service may contract with a third party to process credit card transactions based on reservation, credit card, and price information passed to the third party's server by one of the airline reservation service's systems.

To facilitate the use of web services and similar technologies, the W3C has developed the Simple Object Access Protocol (SOAP), as described in the SOAP Version 1.2 specification, dated Jun. 24, 2003, a copy of which is available on the web at http://www.w3.org/TR/soap12, which is incorporated herein by reference for all purposes. SOAP defines a lightweight communications protocol for sending requests to remote systems, e.g., an RPC to a remote web services platform. SOAP requests and responses are encapsulated in a SOAP “envelope”. The envelope includes a header portion that includes information about the request and how it should be handled and processed and a body portion that includes the request itself and associated data. SOAP requests and responses may be sent using any suitable transport protocol or mechanism, e.g., HTTP. In many cases, the request and associated data included in the body portion of a SOAP request take the form of an XML document (or other infoset), due to the platform and application independent nature of XML as described above.

Whether for purposes of sending and receiving web services requests and responses, e.g., SOAP requests and responses, or for any other purpose requiring an exchange of data, such as in the form of an XML document, it is often important to validate data prior to sending or (if received) processing it, e.g., to detect errors in the data or how it is represented in order to avoid generated incorrect or otherwise undesired results, avoid application or system errors or failure, avoid security breaches or other comprises to data, etc.

One way to validate an XML document, for example, is to verify that the document conforms to the structure and content rules prescribed for the document. Under the XML specification, a document type definition (DTD) may be used to define the structure and content of XML documents of the type defined by a particular DTD. A DTD may be used, e.g., to define the data elements that may occur in an XML document governed by the DTD, the attributes associated with each element, the type (e.g., format or nature) of data values that may be associated with each element and/or attribute, and the relationship of elements to each other (e.g., which elements are sub-elements of which other elements, how many times may an element occur, must elements occur in a particular order, etc.). Other definitions such as XML schema, Schematron (specification available at http://www.schematron.com/spec.html), ASN.1 Module Definitions, or other definition information may be used to define the structure and content of documents.

The XML schema definition language provides additional tools that can be used to define a class of XML documents. The XML schema language is described and defined in the following W3C documents: XML Schema Requirements, dated Feb. 15, 1999, available at www.w3.org/TR/NOTE-xml-schema-req; XML Schema Part 1: Structures, dated May 2, 2001, available at www.w3.org/TR/xml-schema-1; and XML Schema Part 2: Data Types, dated May 2, 2001, available at www.w3.org/TR/xmlschema-2. Like a DTD, an XML schema is used to define data types and prescribe the grammar for declaring elements and attributes. The XML schema language provides an inventory of XML markup constructs that may be used to create a schema that defines and describes a class of XML documents. Syntactic, structural, and value constraints may be specified.

XML parsers configured to use schema to validate XML documents have been provided. For example, a SAX (Simple API for XML available at www.saxproject.org) type XML parser may be configured to use XML schema to validate XML documents. However, such validation may consume significant processing resources and may be difficult to complete in the time required to validate hundreds or thousands of XML documents (e.g., SOAP or other transactions) per second, as may be required in a web services or other environment. Therefore, there is a need for a reliable and efficient way to accelerate validation of XML documents and similar data sets and files using a definition such as an XML schema.

### BRIEF DESCRIPTION OF THE DRAWINGS

Various embodiments of the invention are disclosed in the following detailed description and the accompanying drawings.

FIG. 1A illustrates a validation engine used in some embodiments to validate XML documents.

FIG. 1B illustrates a network web services environment in which an XML gateway used in some embodiments validates XML documents.

FIG. 2 is a flow chart illustrating a process used in some embodiments to perform accelerated schema-based validation.

FIG. 3 illustrates a process used in some embodiments to perform a full schema-based validation, as in step 208 of FIG. 2.

FIG. 4 illustrates a process used in some embodiments to learn the structure and associated validation rules of a document, as in step 210 of FIG. 2.

FIG. 5 illustrates a process used in some embodiments to perform accelerated validation, as in step 214 of FIG. 2.

FIG. 6 is a flow chart illustrating a process used in one embodiment to learn the structure of a document or document type by treating portions that include one or more elements that may occur a variable number of times as a sub-tree requiring special processing.

FIG. 7 illustrates a process used in one embodiment to validate an XML document for which the structure and validation rules have been learned through the process of FIG. 6.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

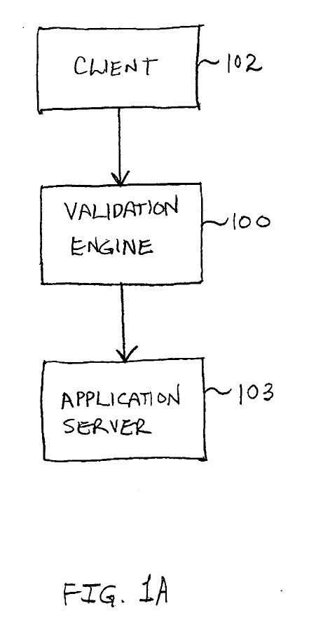

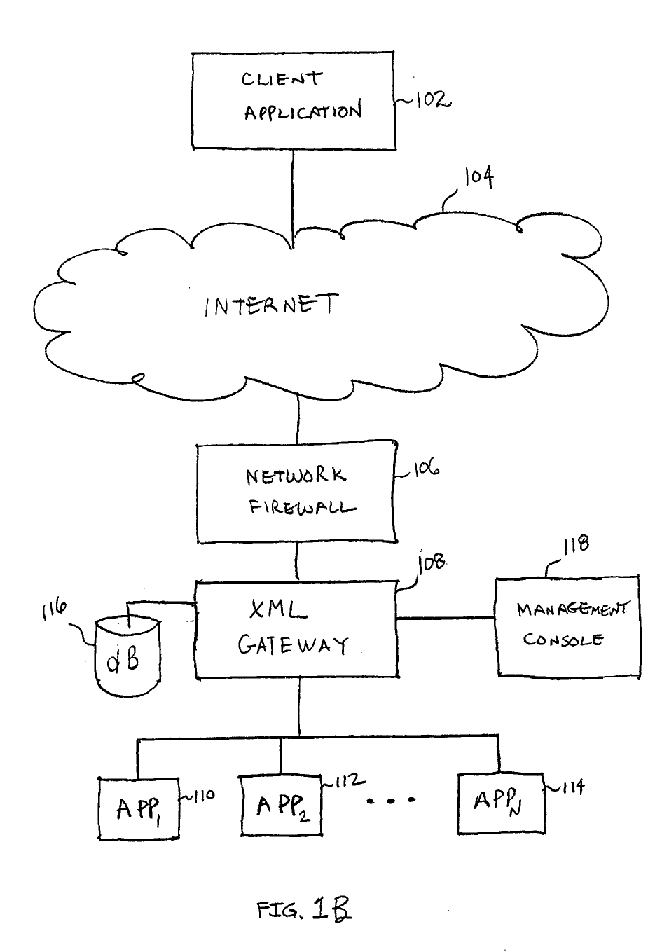

FIG. 1A illustrates a validation engine used in some embodiments to validate XML documents. A validation engine 100 validates XML documents sent by client 102 to application server 103. Client 102 may be a client system or application, or any other device or process that may be configured to send XML documents to application server 103 for processing. For example, client 102 may be a client system configured to send XML documents to application server 103 via a network, such as the Internet, e.g., for purposes of having some computation or other operation performed on the data in the XML document, such as in a web services environment. The validation engine 100 may be a device, system, or process configured to validate the XML document using an accelerated schema-based validation process as described more fully below. In some embodiments, validation engine 100 may be an application or process running on client 102, an application or process running on application server 103, or an application or process running on a system or device interposed between client 102 and application server 103 at some suitable point in the communication path between the two, including for example and without limitation a network device acting as a network proxy and/or gateway, such as the XML gateway described below in connection with FIG. 1B.

FIG. 1B illustrates a network web services environment in which an XML gateway used in some embodiments validates XML documents. In the example shown, a client 102 connects via the Internet 104, a network firewall 106, and an XML gateway 108 to a service running on one (or more) of a group of application servers 1 to N represented in FIG. 1 by servers 110, 112, and 114. In one often-used example, client 102 may send a stock quote request, e.g., a SOAP request, to application server 110, which may be configured to receive the request, process it, and send a response that includes the current price of the stock. Or, the client 102 may send to a route planning service running on application server 112 a list of ten destinations to which an enterprise associated with client 102 desires to deliver goods from a warehouse at a start location specified in the request, with the route planning service being configured to return the quickest route to each destination.

XML gateway 108 is shown in FIG. 1 as having a database 116 and a management console 118 attached to it. The management console 118 is used in some embodiments to configure, monitor, and control the operation of XML gateway 108. In some embodiments, XML gateway 108 is configured to perform accelerated schema-based XML document validation, as described more fully below. XML schema and other validation information are stored in database 116 and used by XML gateway 108 to perform XML document validation. Tables or other data structures storing data associated with XML documents being processed and/or that were previously processed may be stored in database 116 in some embodiments.

In some embodiments, the XML gateway 108 may be configured to perform accelerated XML schema-based validation on an XML document by learning the structure and validation rules of an earlier-received and processed XML document, recognizing that a subsequently received XML document has the same structure as the earlier-received document, and then using the structure and validation rules learned from processing the earlier document to validate the later-received document without performing a full validation using a validating XML parser. In some embodiments, this latter step is performed by using the structure information learned from processing the earlier-received document to find and apply applicable validation rules just to the data values of the later-received document; i.e., by not validating separately the structural portions common to the two documents.

The approach disclosed herein to accelerating structured data validation. In some embodiments, accelerating XML schema-based or similar validation takes advantage of the fact that in many cases, such as in a web services environment, hundreds or thousands of very similarly structured XML documents, e.g., SOAP or other web services requests and/or replies, may need to be validated every second. Often, computers or other devices generate these requests, as opposed to humans, and as a result requests of a particular type (e.g., generated by a particular application, type of server, etc.) tend to be identical in structure and differ only in the values of certain data elements and/or attributes. An XML or similar document can be thought of as having a tree structure. The branches define the structure of the document, which does not vary between documents of a particular type, and “leaf nodes” represent the data values that can change from one instance of the XML document to the next. In the approach disclosed herein, once it is recognized that the structure (i.e., the branches) of two XML documents is the same, only the data values (i.e., the leaf nodes) of the later-received document are validated, using validation rules learned either by pre-processing a schema with which the documents are associated or from processing the earlier-received document. The structure portion is not validated separately for the later-received document because it has already been validated through the validation of the earlier-received document. XML validation is merely an illustrative example. Other forms of structured data may be validated using the approach disclosed herein. In some embodiments, ASN.1 data is validated using the approach disclosed herein.

While the example shown in FIG. 1B includes an XML gateway associated with the application servers 110-114, similar validation may occur that the other end of the transactions between the client 102 and the web services applications running on servers 110-114. For example, an XML gateway (or other validation) system and/or application or process may be interposed between the client 102 and the Internet 104.

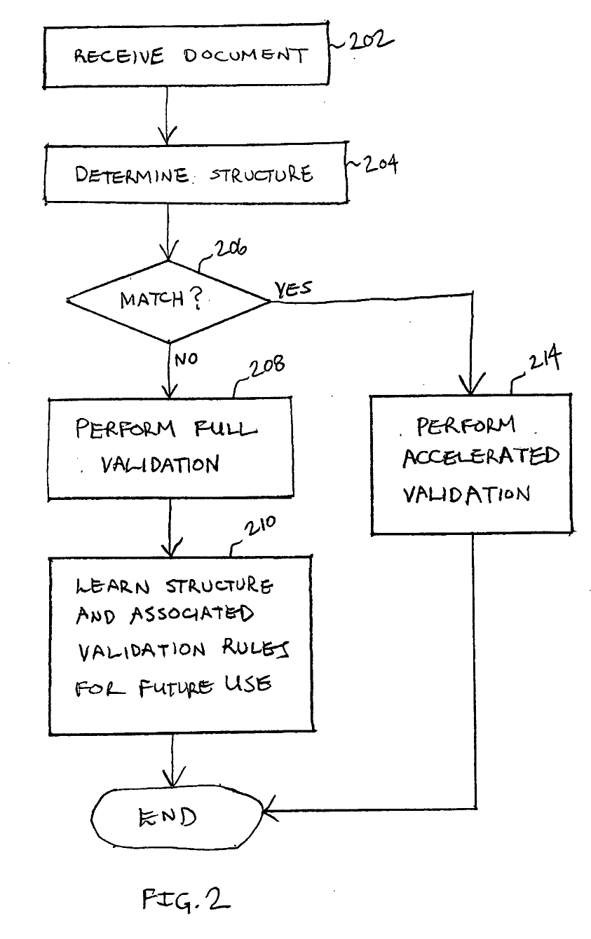

FIG. 2 is a flow chart illustrating a process used in some embodiments to perform accelerated schema-based validation. In step 202, a document is received. The term “document” as used herein refers to any collection or representation of data in any format susceptible to being validated as described herein, including without limitation XML or other documents, data or other files, etc. In step 204, the document structure is determined. In some embodiments, the document structure is determined by parsing the document using a non-validating parser to identify those portions that are part of the structure of the documents, as opposed to data values (i.e., the leaf nodes). Consider the following XML document as an example:

```
<toy>
    <type>ball</type>
    <color>red</color>
</toy>
```

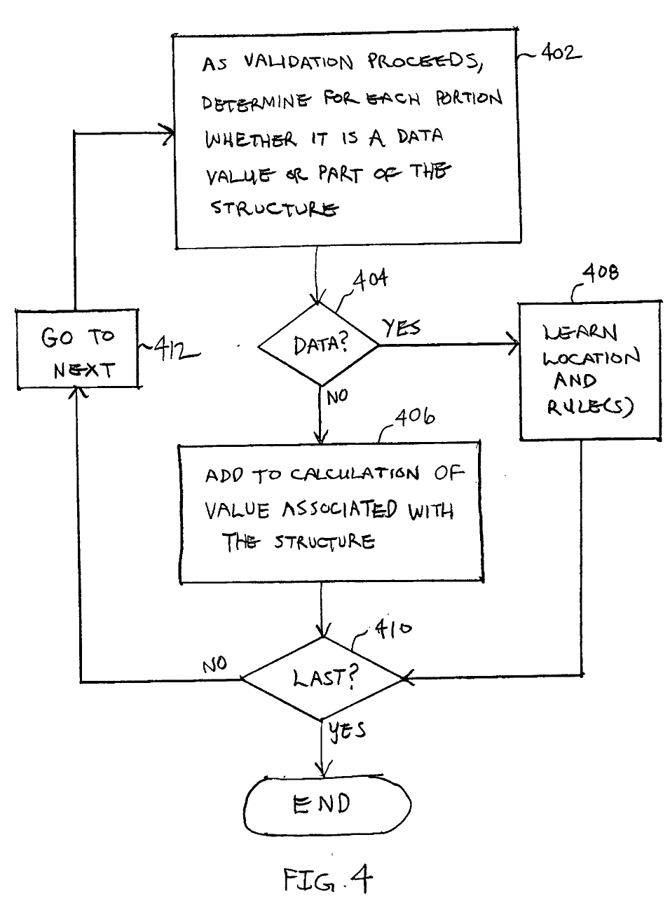

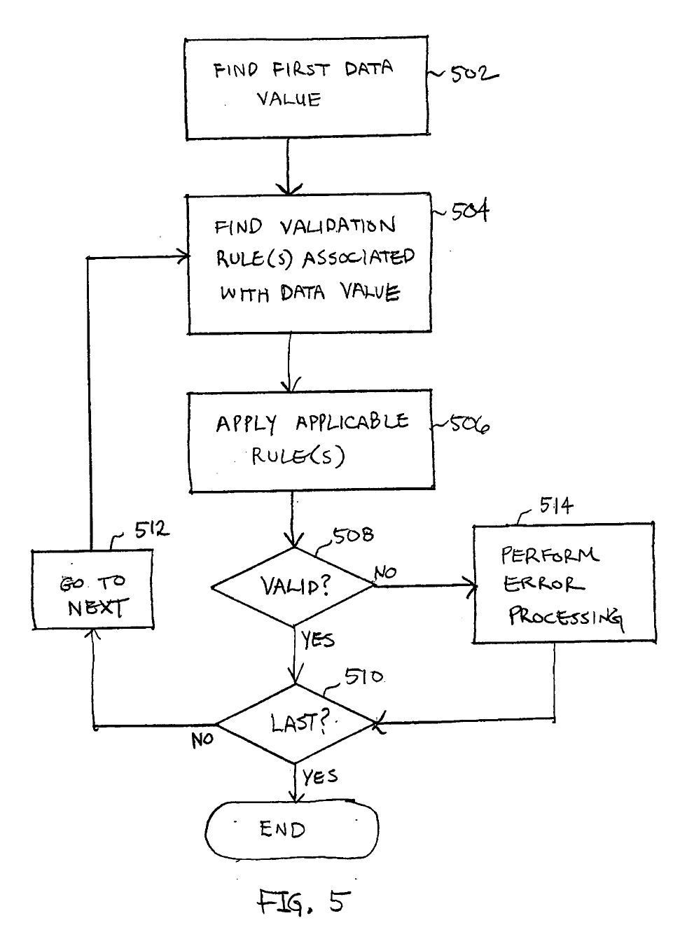

This simple document describes a toy that is a red ball. Such a document might be an instance of a class of documents defined by an XML schema that defines an element “toy” having a first sub-element “type” and a second sub-element “color” each of which can have a string of characters as its data value. The schema might define further constraints for either the sub-elements or their associated data values, e.g., constraints relating to the order in which the sub-elements must appear, the number of times each sub-element must or may appear, etc. A SAX-type parser is used in some embodiments to distinguish between structural portions and data values. A SAX parser recognizes strings in the form <tag> as element start tags and strings in the form </tag> as element end tags. Each such start or end tag generates an “event” that initiates appropriate parsing by the parser to identify and extract the elements and data values associated with the start and/or end tag. In some embodiments, the structure portions of the document are identified and added to the portions of the document used to calculate a value representative of the structure of the document, sometimes referred to herein as a “structure value”. In some embodiments, the structure value is a hash value calculated based on the string of characters associated with the structure of the document. Use of a parser to distinguish between structure portions and data values is discussed more fully below, e.g., in connection with FIGS. 4 and 5.

In some embodiments, the determination performed in step 204 is based on only a subset of the data associated with the document. For example, a SOAP envelope and header might not be included in the calculation of the structure value. Also, information such as the version of XML being used, e.g., might not be included in the calculation.

In step 206 of the process shown in FIG. 2, it is determined whether the structure of the received document matches the structure of a previously received and validated document. If the received document does not match the structure of a previously received and validated document, the process proceeds to step 208, in which a full schema-based validation of the document is performed. In some embodiments, a validating parser, such as a SAX parser configured to perform schema-based validation, is used. In step 210, the structure of the received document and associated validation rules are learned as the full validation of step 208 proceeds. In some embodiments, the information learned in step 208 includes the location of data values that require validation and the validation rule(s) applicable to the data values. Steps 206 and 208 may proceed simultaneously, serially, and/or in any order, depending on the implementation.

If it is determined in step 206 that the structure of the received document matches the structure of a previously received and validated document, the process advances to step 214 in which an accelerated validation is performed. Information learned from validating the previously received document is used to validate the current document without performing a full schema-based validation. In some embodiments, information about the location in documents having the structure of the received document of data values to be validated and the validation rule(s) applicable to each data value that was learned from processing the previously received document that had the same structure is used to quickly validate just the data values in the later-received document. In some embodiments, the structural portions of the later-received document, which were validated fully in the previously received document and which have been determined in step 206 to be the same as the corresponding portions of the previously received document, are not validated for the later-received document. In some embodiments, while the structure is determined in step 204 an array of element and attribute data values is built in which each data value associated with the result of the structure value calculation up to the point in the document at which the data value is found. In such embodiments, step 214 comprises running quickly through the array of data values, finding the applicable validation rule(s) by finding for each data value the corresponding entry in the table or other structure associated with the previously processed document having the same structure, and applying to each value to rules applicable to it. Once the accelerated validation is completed, the process ends. In some embodiments, the structure of a type of XML document may be learned by preprocessing a schema associated with the document type.

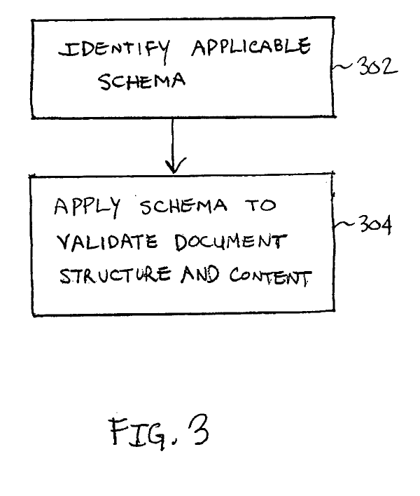

FIG. 3 illustrates a process used in some embodiments to perform a full schema-based validation, as in step 208 of FIG. 2. In step 302, the schema that applies to the XML document to be validated is identified. In some embodiments, information included within the document itself, e.g., the root element, may be used to identify the schema that governs the document. In some embodiments, the document to be validated may itself include a DTD, schema, Schematron, ASN.1 Module Definitions, or other definition information that can be used to validate the document. In some embodiments, the document may include a pointer to a location from which the schema may be retrieved. In step 304, the schema is applied to validate the structure and content of the document. Consider the example from above:

```
<toy>
    <type>ball</type>
    <color>red</color>
</toy>
```

The schema for the above document might be identified, e.g., based on the root element <toy>, or other identifying information in the document. The schema might, e.g., define a structure in which each element <toy> must comprise one and only one sub-element <type> and may comprise either no or one sub-element <color>, each sub-element being a character string. Validation would comprise checking to see that the element <toy> in the above instance of the class of documents defined by the schema satisfies all the constraints defined in the schema. In this case, it would be determined that the element <toy> comprises the required sub-element <type> with an associated data value that is valid for that sub-element (i.e., the character string “ball”) and permissibly includes one occurrence of the optional sub-element <color> with an associated data value that is valid for that sub-element (i.e., the character string “red”). The schema might impose further or different constraints than those supposed above by way of example.

FIG. 4 illustrates a process used in some embodiments to learn the structure and associated validation rules of a document, as in step 210 of FIG. 2. In step 402, as validation proceeds, it is determined for each portion validated whether the portion is a data value or part of the structure of the document. In some embodiments, the process of FIG. 4 proceeds in parallel with the process of FIG. 3, for example in an embodiment in which a SAX type processor is used to validate the document. If a portion is not a data value (404), the process proceeds to step 406, in which the portion is added to a calculation of a value representative of the structure of the document. In some embodiments, step 406 comprises adding the portion to the string of characters used to calculate a hash value representative of the structure of the document. In some embodiments, this is done by performing an XOR operation to add the portion to a hash value associated with the previously added portions.

If the portion being processed is a data value (404), the process advances to step 408, in which the location of the data value within the document and any associated validation rule(s) are learned. In some embodiments, the location of the data element is learned by storing the current value for the structure value computed in step 406 as of the most recently processed structural portion, because that value represents the structural portions of the document up to that point in the document and would be the same as the corresponding value calculated for a subsequently received document having the same structure. In some embodiments, the location of the data value and associated validation rules are stored in a data structure, such as a table. In some embodiments, a pointer to the validation rule is stored.

Once a portion of the document has been identified and processed as either a structure portion or a data value in step 406 or step 408, as applicable, it is determined in step 410 whether the portion just processed is the last portion of the document required to be processed. If the portion just processed is determined to be the last portion required to be processed, the process ends. Otherwise, the next portion to be processed is received or identified in step 412 and the process repeats as to that portion and any subsequent portions until the entire document has been processed.

FIG. 5 illustrates a process used in some embodiments to perform accelerated validation, as in step 214 of FIG. 2. In step 502, the first data value in the document is found. In some embodiments, the first and subsequent data values may be found by parsing the document until a data value (leaf node) is encountered. In some embodiments, an array of data values and their respective locations in the document, identified for example by the value of the structure value as calculated up to the point where the data element is found, is built when the document is first parsed to determine its structure, as in step 204 of FIG. 2 and in such embodiments steps 502 and 512 (described below) comprise obtaining a next value in order (or not) from the data array. In some embodiments, the information about the structure of the document learned by processing the previously received document having the same structure is used to quickly locate the data values in the subsequently received document on which accelerated validation is being performed. In step 504, the validation rule(s) to be applied to the data value are found. In some embodiments, as the document is parsed a structure value representing the structure portions of the document up to the most recently processed portion is calculated and step 504 comprises using the structure value representing the structure of the document up to the point at which the data value is located as the index of a table or other data structure in which the validation rule(s) applicable to the data value, or a pointer to such rule(s), is/are stored. If a hash value is used as the structure value, the structure value for each data value location is highly likely to occur only once for any given document, making the structure value suitable for use as an index. The applicable validation rule(s) is/are applied in step 506. In step 508, it is determined whether the applicable validation rule(s) was/were satisfied (i.e., is the data value valid). If it is determined that the data is valid, to process proceeds to step 510, in which it is determined whether the document contains any further data values that require validation. If the data value just processed was the last one required to be validated the process ends. Otherwise, the next data value is found in step 512 and the process repeats as to the next data value.

If it is determined in step 508 that one or more applicable validation rules are not satisfied by the data value, error processing is performed in step 514. The error processing may comprise sending an alert, blocking a request or response associated with the document, setting a flag in a request or response, or any other responsive action that may be desired or appropriate in a particular implementation. Once the error handling has been performed, the process proceeds to step 510 and continues as described above. In some alternative embodiments, if invalid data is detected in step 508, the processing of a document ends after error process has been performed in step 514. In such embodiments, the arrow shown in FIG. 5 as running from step 514 to step 512 would instead run from step 514 to the “end” block.

If the process of FIG. 5 is completed without any error being detected, the document is considered valid and it is processed normally.

By using the accelerated approach described above, time and computing resources are saved because the structure portions of the subsequently received document, which is the same as the corresponding previously validated document, is not validated again each time a document having the same structure is received. Also, the data values that require validation, as well as the validation rule(s) that apply to them, can be located quickly without requiring that the schema be consulted and processed, for example.

In some embodiments, the processes shown in FIGS. 4 and 5 may be modified to take into account features and aspects of XML and/or other languages used to define how data is represented. For example, in XML it is permitted to include data values known as “attributes” within an XML tag. For example, the data in the simple example considered above:

```
<toy>
    <type>ball</type>
    <color>red</color>
</toy>
```

may also be defined to be represented as:

<toy type = “ball”>
<color>red</color>
</toy>

In some embodiments, attributes embedded in XML tags are identified as leaf nodes and validated individually as described above. In some such embodiments, the name of the attribute is added to the structure value calculation and the data value added to an array of data values to be validated. A SAX type parser, for example, could be configured to recognize such attributes included in tags and generate an “event” when an attribute is encountered. In other embodiments, at least certain types of data values included as attributes defined within tags are validated during full validation but are processed as part of the “structure” of the document for purposes of the processes of FIGS. 4 and 5. For example, in some embodiments if an attribute name starts with “xmlns:” or is “xmlns”, or starts with “xsi:” or is “xsi”, or for any other attributes that affect the structure of a document and/or its semantics, the attribute name and value are both included in the structure value calculation and the data values are not added to the data array. This generates more unique document types, because a subsequently received document would only be a match if it were to have the same values for the attributes as a previously processed document. However, in some environments, e.g., web services, it is not uncommon to have hundreds or thousands of requests with the same attribute values but other data values that vary. In such environments, the approach described herein would still result in substantial savings in time and resources even if a new “structure” family were defined each time a single attribute value varied from otherwise like documents received previously. Also, in some environments and/or community developers avoid including attributes in XML or other tags and as a result it is more common for data values to appear separately, set off by start and end tags, as opposed to within tags.

A further consideration is the fact that an XML schema may or may not specify or require a particular order of elements. If a specific order is not required, the order of elements may vary between different instances of the same document class/schema, even though the documents are structurally identical in all other respects. In some embodiments, this variability is addressed by reordering elements to ensure that the elements in documents associated with a particular schema appear in the same order, and then calculating a structure value on the reordered document, e.g., for purposes of determining whether the structure is the same as a previously processed document, as in steps 204 and 206 of FIG. 2, such that accelerated validation may be performed. In other embodiments, no separate provision is made for addressing such variability in the order in which elements appears. This may result in a proliferation of unique structure types, e.g., because two otherwise identical documents in which two elements appear in a different order would not have the same structure value, but such proliferation may not be a problem and/or substantial savings may still be realized despite such proliferation in environments in which a large volume of documents are machine generated, because machines tend to use the same algorithm or code to generate documents of a particular type which results in their often using the same order of elements.

Finally, the number of at least certain elements may vary between valid instances of a single class of documents defined by the same schema. For example, in an organization chart document, the root element <orgchart> may be permitted to include one or more department sub-elements, e.g., <dept>, each of which may include one or more employee name sub-elements, e.g., <employeeName>. Two valid instances of such a class may have varying numbers of departments and/or different numbers of employees within one or more departments, which might result in their structure values determined as described above being different even though their structures are very similar. In some embodiments, the potential variation in the number of occurrences of an element is handled with respect to an element that must occur once but may occur more times by calculating the structural value using only the first occurrence of such an element and omitting subsequent occurrences from the structure value calculation. In some embodiments, an element that may not occur at all in a valid instance of a schema is omitted entirely from the structure value calculation, whether it occurs or not. This approach has the benefit of reducing the number of unique structures of which one must keep track. However, it complicates the task of quickly determining the location of data values in any particular instance of the class defined by the schema and associating validation rules with the data values. In some embodiments, the proliferation of unique structure values (or types) is tolerable and no attempt is made to associate documents of the same type but different numbers of elements together. Instead, each unique structure generates a unique structure value and associated data value location and validation rule information, and only those subsequently received documents that have the exact same structure (i.e., down to the number of occurrence of the various elements) are determined to have the same structure for purposes of performing accelerated validation.

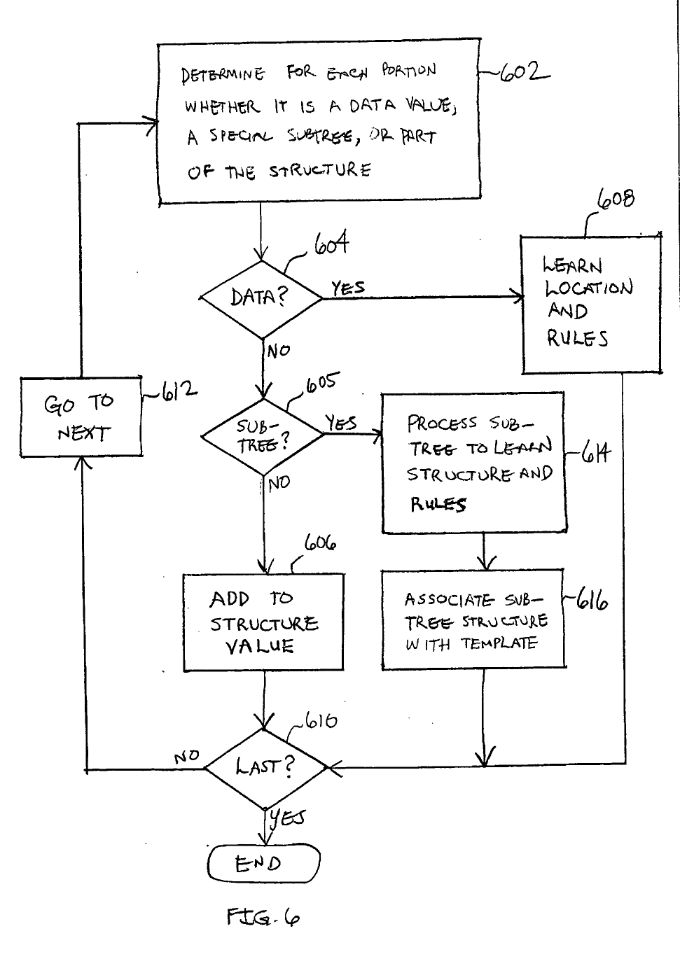

In some embodiments, the structure of a document type in which the number of times that one or more elements occur may vary is learned by modifying the process of FIG. 4 to identify as a sub-tree requiring special processing (referred to herein as a “special sub-tree”) any portions that include elements that may validly occur a variable number of times, and then recursively applying the structure learning algorithm to such special sub-trees to learn their structure. FIG. 6 is a flow chart illustrating a process used in one embodiment to learn the structure of a document or document type by treating portions that include one or more elements that may occur a variable number of times as a sub-tree requiring special processing. In step 602, it is determined for each portion of the document whether it is a data value, a special sub-tree, or part of the structure of the document. If a portion is a data portion (604), the location of the data value in the structure of the document and the applicable rules for validating the data value are learned, as in step 408 of FIG. 4. If a portion is a special sub-tree (605), the special sub-tree is processed in step 614 to learn the structure and validation rules applicable to the sub-tree, and the sub-tree structure and validation rule information are associated in step 616 with the overall document structure being learned through the process shown in FIG. 6. In some embodiments, the processing of step 614 comprises performing with respect to the sub-tree the process of FIG. 6, such that the process of FIG. 6 is performed recursively for any special sub-tree and for special sub-trees within any special sub-tree. In some embodiments, step 614 comprises performing the process of FIG. 6 recursively with respect to each element of the special sub-tree. If a portion is neither a data value nor a special sub-tree, in step 606 it is added to the structure value for the document type, as in step 406 of FIG. 4. Once a portion has been processed as either a data value (608), a special sub-tree (614 and 616), or a structure portion (606), it is determined in step 610 whether the portion was the last portion of the document. If the portion was the last portion, the process ends. Otherwise, the next portion is identified in step 612 and the process repeats for that portion until all portions have been processed.

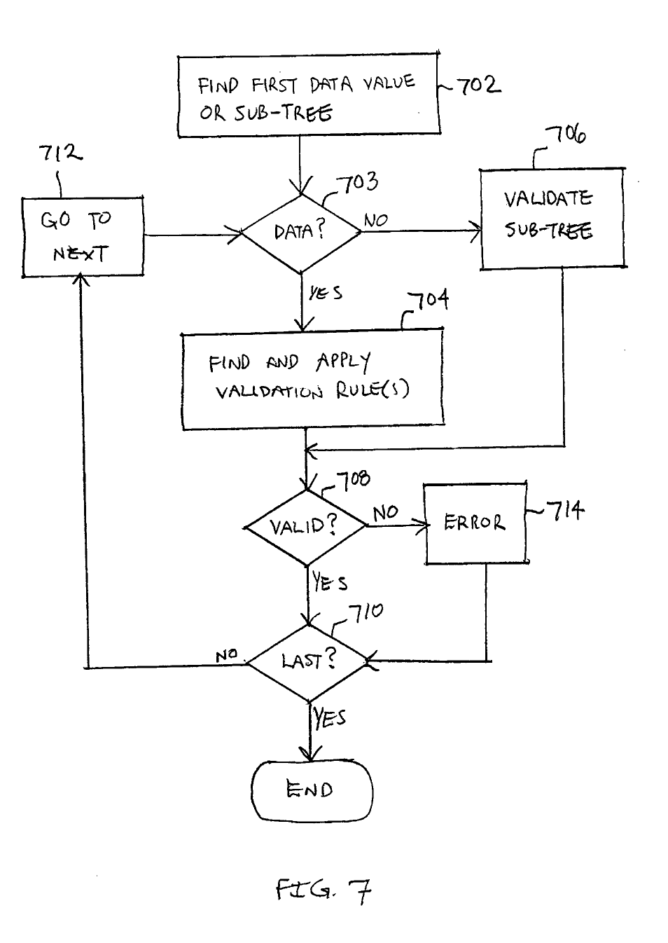

FIG. 7 illustrates a process used in one embodiment to validate an XML document for which the structure and validation rules have been learned through the process of FIG. 6. In step 702, the first data value or special sub-tree is found. If it is a data value that has been found (703), the validation rules for the data value are found and applied, as in steps 504 and 506 of FIG. 5. If it is not a data value that has been found, i.e., it is a special sub-tree, the special sub-tree is validated in step 706. In some embodiments, step 706 comprises finding the rules for validating the special sub-tree by calculating a structure value for the special sub-tree, using that value to find previously-learned data location and validation rule information for the special sub-tree, and performing the process of FIG. 7 with respect to the special sub-tree. In such an embodiment, the process of FIG. 7 is performed recursively on any special sub-tree and all special sub-trees within a special sub-tree until all portions of the overall document have been validated. In some embodiments, step 706 comprises performing the process of FIG. 7 recursively with respect to each element (or special sub-tree) of the special sub-tree. Once the data value or special sub-tree has been validated, it is determined in step 708 whether the validation process indicated the data value or special sub-tree is valid. If the data value or special sub-tree was not found to be valid, error processing is performed in step 714, as in step 514 of FIG. 5. If the data value or special sub-tree was found to be valid, it is determined in step 710 whether the portion just processed was the last portion of the document that required validation. If it was the last portion, the process ends. Otherwise, the next data value or special sub-tree is found and steps 703-710 are performed, as applicable, with respect to the next data value or special sub-tree until all data values and special sub-trees have been processed.

In some embodiments, special provisions are made to avoid having two documents being determined to have the same structure value, such that only the data values are validated, even if the structural portion of the document is not well formed. For example, in some embodiments a character “e” is added to the structure value calculation whenever an end tag is encountered (i.e., a tag in the form </tag>) to avoid having the following two documents being found to have the same structure value: <foo><bar>text</bar></foo> and <foo><bar>text</foo>. In some embodiments, provisions are similarly made for such variations as permissible white spaces, start tag and end tag pairs that do not include any data value, etc.

The use of the XML meta-language format and XML associated definitions is merely an illustrative example. Other meta-language formats, other structured document formats, and other associated definitions may be used in one or more of the processes and systems described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for performing accelerated validation of a first set of data, comprising:
identifying a structure associated with the first set of data;
determining whether the structure of the first set of data matches a previously learned structure; and
if a match is found, performing an accelerated validation of the first set of data using validation information associated with the previously learned structure.

2. A method as recited in claim 1, wherein the validation information includes information determined during learning of the previously learned structure.

3. A method as recited in claim 1, wherein the validation information includes a location of a data value within the previously learned structure.

4. A method as recited in claim 1, wherein the validation information includes a validation rule associated with a data value within the previously learned structure.

5. A method as recited in claim 1, wherein the previously learned structure comprises one of a set of one or more previously learned structures.

6. A method as recited in claim 1, wherein the previously learned structure was learned at least in part by processing a definition or schema associated with the previously learned structure.

7. A method as recited in claim 1, wherein the previously learned structure was learned at least in part by processing a previously received set of data.

8. A method as recited in claim 1, wherein the first set of data comprises a structured or formatted document or message.

9. A method as recited in claim 1, wherein performing the accelerated validation includes locating a data value in the first set of data using a structure value associated with the previously learned structure.

10. A method as recited in claim 1, further comprising performing a full validation of the first set of data if a match is not found.

11. A method as recited in claim 10, wherein the full validation includes calculating a structure value representative of at least a portion of a structure of the first set of data.

12. A method as recited in claim 11, wherein the structure value represents a location within the first set of data of a data value with which the structure value is associated.

13. A method as recited in claim 11, further comprising storing in a data structure a validation rule associated with the structure value.

14. A method as recited in claim 11, wherein calculating the structure value includes calculating a hash value based at least in part on a string of characters associated with one or more structural portions of the first set of data which one or more structural portions occur in the first data set prior to a data value with which the structure value is associated.

15. A method as recited in claim 1, wherein identifying the structure associated with the first set of data includes calculating one or more structure values, determining whether the structure of the first set of data matches a previously learned structure includes comparing one or more structure values associated with the first set of data to one or more corresponding structure values associated with the previously learned structure, and performing the accelerated validation of the first set of data includes applying to each of one or more data elements comprising the first set of data one or more corresponding validation rules associated with the previously learned structure, wherein the one or more corresponding validation rules are identified for each of said one or more data elements based at least in part on a calculated structure value that represents a location of the data element within the first set of data.

16. A method as recited in claim 1, wherein performing the accelerated validation includes not validating in the first set of data at least one structural portion common to the first set of data and the previously learned structure.

17. A method as recited in claim 1, wherein the first set of data is reordered prior to determining whether the structure of the first set of data matches a previously learned structure to ensure that an ordering of data in the first set of data matches a schema associated with the first set of data or an ordering of data associated with the previously learned structure.

18. A system for performing accelerated validation of a first set of data, comprising:
a processor configured identify a structure associated with the first set of data, determine whether the structure of the first set of data matches a previously learned structure, and if a match is found, perform an accelerated validation of the first set of data using validation information associated with the previously learned structure; and
a memory coupled to the processor to store the validation information.

19. A system as recited in claim 18, wherein the processor is further configured to perform a full validation of the first set of data if a match is not found.

20. A system as recited in claim 18, wherein the processor is further configured to calculate a structure value that represents a location within the first set of data of a data value with which the structure value is associated.

21. A system as recited in claim 18, wherein the processor is further configured to calculate a structure value that represents a location within the first set of data of a data value with which the structure value is associated including by calculating a hash value based at least in part on a string of characters associated with one or more structural portions of the first set of data which one or more structural portions occur in the first data set prior to the data value.

22. A system as recited in claim 18, wherein the system comprises one or more of the following: a client, an application server, a system or device interposed between a client and an application server, a network proxy, a firewall, a gateway, a XML gateway, and an ASN.1 gateway.

23. A computer program product for performing accelerated validation of a first set of data, the computer program product being embodied in a computer readable medium and comprising computer instructions for:
identifying a structure associated with the first set of data;
determining whether the structure of the first set of data matches a previously learned structure; and
if a match is found, performing an accelerated validation of the first set of data using validation information associated with the previously learned structure.
